(19) United States
(12) Patent Application Publication
(10) Pub. No.: US 2016/0162914 A1
(43) Pub. Date: Jun. 9, 2016

(54) ONLINE SURVEY RESULTS FILTERING TOOLS AND TECHNIQUES

(71) Applicant: SURVEYMONKEY INC., Palo Alto, CA (US)

(72) Inventors: Joshua Hornik, Burlingame, CA (US); Brad Phillips Olcott, San Francisco, CA (US)

(21) Appl. No.: 14/558,901

(22) Filed: Dec. 3, 2014

(51) Int. Cl. G06Q 30/02; G06F 17/30

(52) U.S. Cl. CPC G06Q 30/0203; G06F 17/30867

(57) ABSTRACT

An electronic device-controlled method can include a first electronic device creating one or more online survey quotas for an online survey responsive to instructions from a user, the online survey including multiple online survey questions. The method can also include a second electronic device automatically generating one or more online survey results views for the online survey based on the one or more online survey quotas. The method can also include a third electronic device visually presenting to another user an online survey results view interface configured to allow the user to select a certain one of the one or more online survey results views for the online survey.

### TECHNICAL FIELD

The disclosed technology generally pertains to various types of systems and methods for filtering results of online surveys that are administered by way of electronic devices such as personal computers and mobile electronic devices, e.g., smartphones and tablet computing devices.

### BACKGROUND

Online surveys have become increasingly valuable to individuals, companies, and virtually all types of organizations by enabling such entities to quickly and efficiently obtain various types of information from any number of target populations. Such information may include customer preferences, feedback on products and/or services, and customer service-related information, for example. Companies may incorporate such information in making various business and/or strategic or otherwise tactical decisions. Additionally, the continued prevalence of mobile electronic devices, such as smartphones and tablet computing devices, in today's society provides individuals, business entities, and other groups with even greater access to virtually every type of target populations for electronic surveys and other information-gathering mechanisms. Indeed, millions of people around the world use the Internet or other networks on a regular—often daily—basis, both at home and at their workplace. Accordingly, there remains a constant need for further improvements in creating and administering online surveys as well as analyzing online survey results from online surveys that are taken by online survey participants.

### BRIEF DESCRIPTION OF THE DRAWINGS

FIG. 1 illustrates an example of a networked system in accordance with certain embodiments of the disclosed technology.

FIG. 2 illustrates an example of an electronic device in which certain aspects of various embodiments of the disclosed technology may be implemented.

FIG. 3 is a flowchart illustrating an example of an electronic device-controlled method in accordance with certain embodiments of the disclosed technology.

FIG. 4 illustrates an example of an Add Quota interface configured to enable a user to establish at least one quota for a particular online survey in accordance with certain embodiments of the disclosed technology.

FIG. 5 illustrates an example of an online survey results view interface configured to enable a user to select a certain online survey results view for a particular online survey in accordance with certain embodiments of the disclosed technology.

FIG. 6A illustrates a first example of an Answer interface configured to visually provide a user with information pertaining to results for a first question of a particular online survey in accordance with certain embodiments of the disclosed technology.

FIG. 6B illustrates a first example of an Answer interface configured to visually provide a user with information pertaining to results for a second question of the online survey in accordance with certain embodiments of the disclosed technology.

FIG. 6C illustrates a first example of an Answer interface configured to visually provide a user with information pertaining to results for a third question of the online survey in accordance with certain embodiments of the disclosed technology.

FIG. 7A illustrates a second example of an Answer interface configured to visually provide a user with information pertaining to results for a first question of a particular online survey in accordance with certain embodiments of the disclosed technology.

FIG. 7B illustrates a second example of an Answer interface configured to visually provide a user with information pertaining to results for a second question of the online survey in accordance with certain embodiments of the disclosed technology.

FIG. 7C illustrates a second example of an Answer interface configured to visually provide a user with information pertaining to results for a third question of the online survey in accordance with certain embodiments of the disclosed technology.

### DETAILED DESCRIPTION

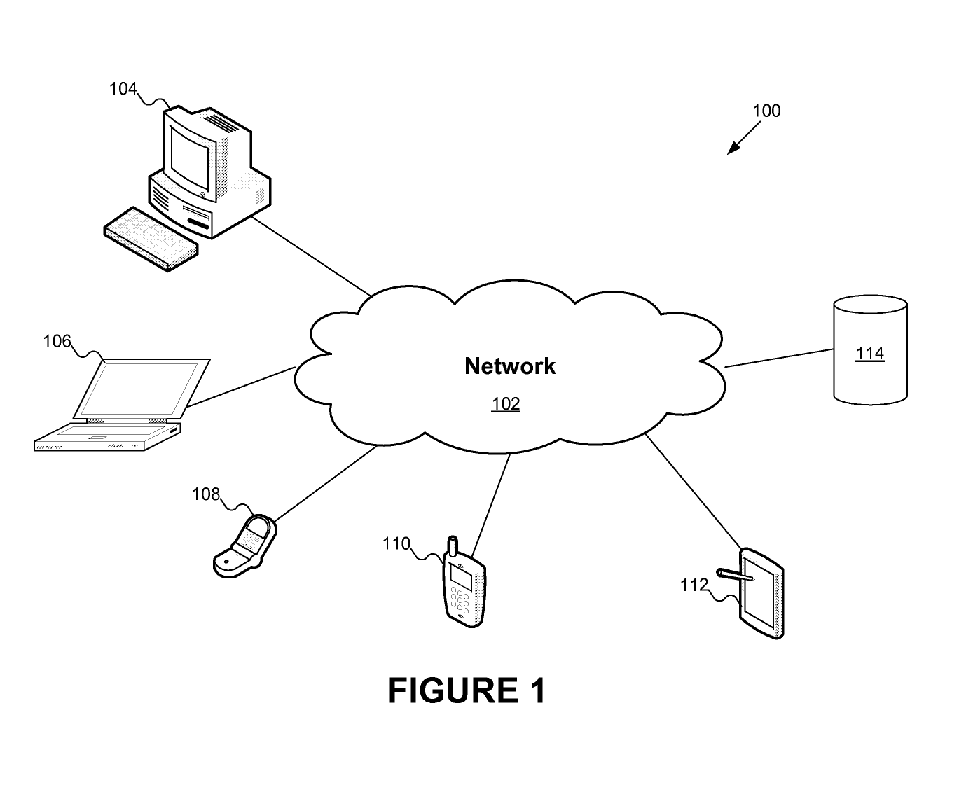

FIG. 1 illustrates an example of a networked system 100 in accordance with certain embodiments of the disclosed technology. In the example, the system 100 includes a network 102 such as the Internet, an intranet, a home network, a public network, or any other network suitable for implementing embodiments of the disclosed technology. In the example, personal computers 104 and 106 may connect to the network 102 to communicate with each other or with other devices connected to the network.

The system 100 also includes three mobile electronic devices 108-112. Two of the mobile electronic devices 108 and 110 are communications devices such as cellular telephones or smartphones. Another of the mobile devices 112 is a handheld computing device such as a personal digital assistant (PDA), tablet device, or other portable device. A storage device 114 may store some of all of the data that is accessed or otherwise used by any or all of the computers 104 and 106 and mobile electronic devices 108-112. The storage device 114 may be local or remote with regard to any or all of the computers 104 and 106 and mobile electronic devices 108-112.

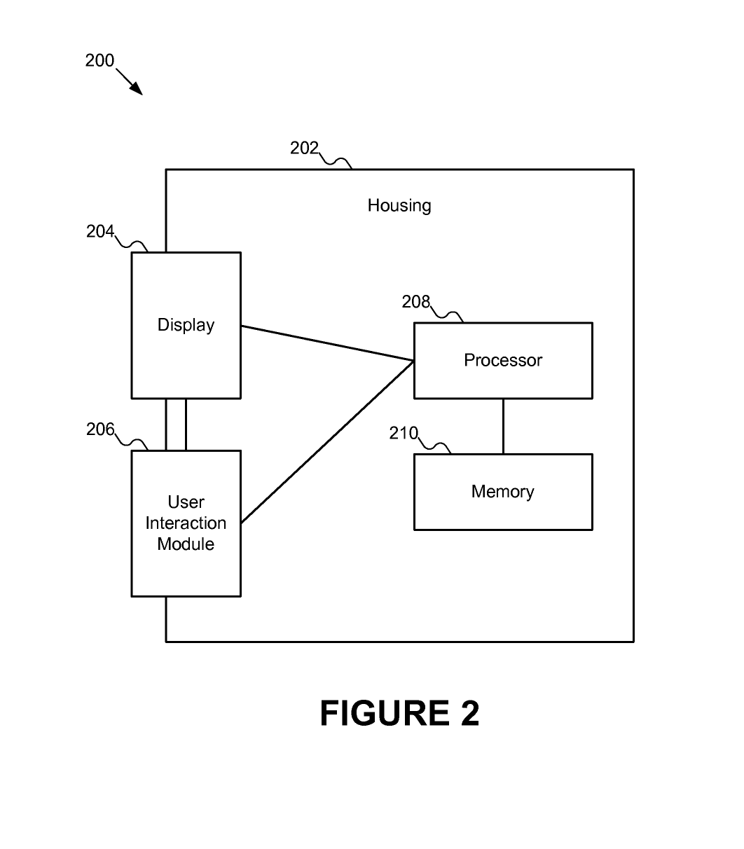

FIG. 2 illustrates an example of an electronic device 200, such as the devices 104-112 of the networked system 100 of FIG. 1, in which certain aspects of various embodiments of the disclosed technology may be implemented. The electronic device 200 may include, but is not limited to, a personal computing device such as a desktop or laptop computer, a mobile electronic device such as a PDA or tablet computing device, a mobile communications device such as a smartphone, an industry-specific machine such as a self-service kiosk or automated teller machine (ATM), or any other electronic device suitable for use in connection with certain embodiments of the disclosed technology.

In the example, the electronic device 200 includes a housing 202, a display 204 in association with the housing 202, a user interaction module 206 in association with the housing 202, a processor 208, and a memory 210. The user interaction module 206 may include a physical device, such as a keyboard, mouse, microphone, speaking, or any combination thereof, or a virtual device, such as a virtual keypad implemented within a touchscreen. The processor 208 may perform any of a number of various operations. The memory 210 may store information used by or resulting from processing performed by the processor 208.

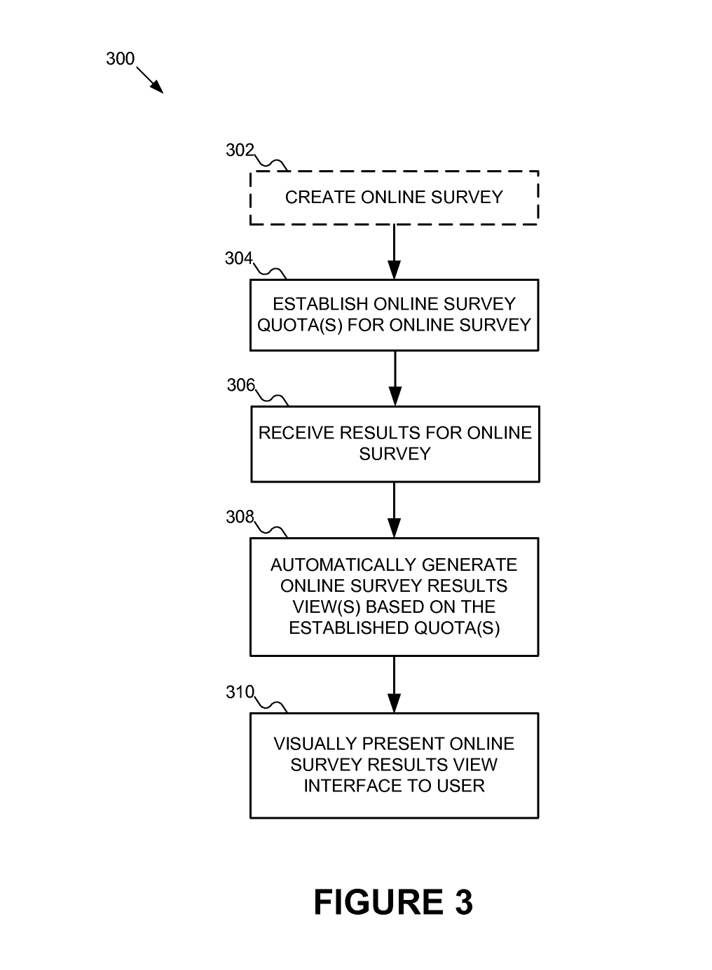

FIG. 3 is a flowchart illustrating an example of an electronic device-controlled method 300 in accordance with certain embodiments of the disclosed technology.

At 302, at least one online survey is created. Each created online survey generally includes multiple questions. In certain embodiments, one or more online surveys that were previously created may be used in addition to or in place of one or more newly-created online surveys.

At 304, at least one online survey quota is established for a particular online survey. For example, a user may establish an online survey quota to indicate a desired number of online survey takers for the online survey that meet at least one specified criterion, e.g., are of a particular gender and/or have a particular preference with regard to a trait or characteristic that is identifiable and/or measurable such as age or favorite color. One or more filters may be used to determine which online survey takers meet each of the specified criteria, for example.

As used herein, the term online survey quota generally refers to a defined group representing both the minimum and maximum number of online survey takers that meet the one or more specified criteria and whose responses to the online survey are to be recorded. In certain embodiments where the number of online survey takers that meet the one or more specified criteria exceeds the online survey quota, the user may be provided an option to either ignore or take into account the responses of the online survey takers in excess of the responses of the online survey takers that had already met the established quota.

At 306, results of the particular online survey are received. For example, raw data including at least the individual online survey takers' answers to at least some of the questions of the particular online survey may be received directly or indirectly from the online survey takers that have at least partially taken the online survey.

At 308, at least one online survey results view for the online survey is automatically generated based on the at least one quota established at 304. For example, a particular online survey results view may be used to visually indicate to a user whether a particular quota has been met and, if not, how many of the survey takers that met the at least one criteria for the quota have provided answers to at least some of the questions of the online survey. Alternatively or in addition thereto, a particular online survey results view may be used to visually indicate to a user information pertaining to responses to the online survey questions by online survey takers that met the at least one criteria for the quota.

One having ordinary skill in the art will appreciate that each of the actions described at 306 and at 308 may happen in any given order, including at least substantially concurrently with each other. For example, the at least one survey results view that is generated at 308 may be generated immediately upon completion of the establishing of the at least one online survey quota at 304—and prior to the receipt of any online survey results at 306.

At 310, an online survey results view interface is visually presented to a user, e.g., by way of a monitor or other suitable electronic display device or component. The online survey results view interface may be configured to enable a user to select a particular online survey results view and, in situations where there are multiple online survey results views, switch between any or all of the online survey results views.

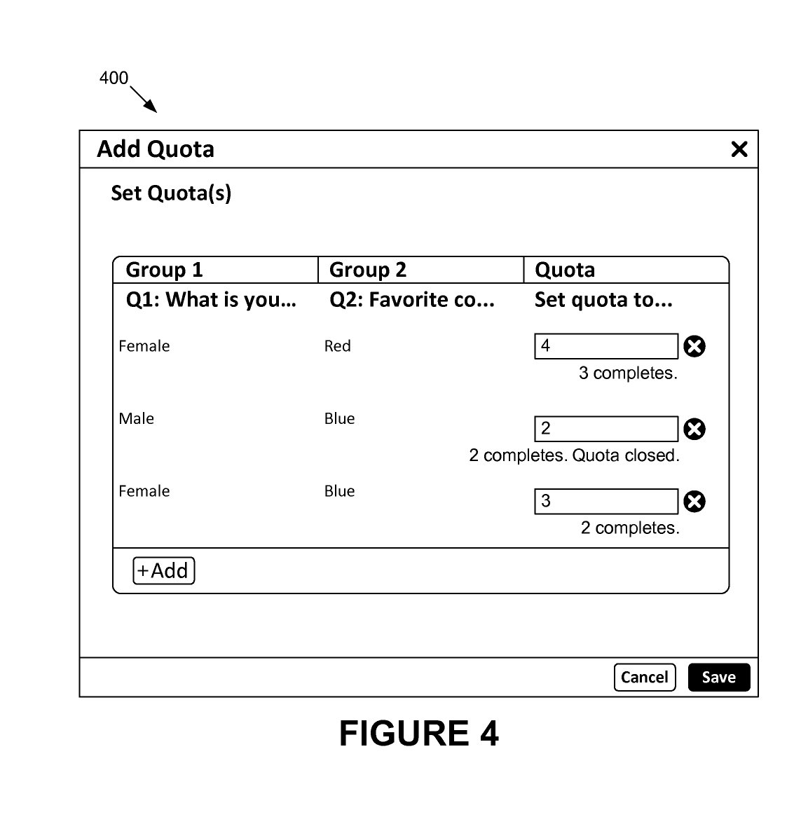

FIG. 4 illustrates an example of an Add Quota interface 400 configured to enable a user to establish at least one quota for a particular online survey, e.g., as described at 304 of the electronic device-controlled method 300 illustrated by FIG. 3, in accordance with certain embodiments of the disclosed technology. In the example, an Add button of the Add Quota interface 400 may be used by the user to establish any additional quotas and, once the user has specified all of the desired quotas, a Save button of the Add Quota interface 400 may be used by the user to cause the specified quotas to be saved. A Remove button (e.g., as indicated by an X within a circle to the right of each quota) may be used by the user to cause a particular quota to be removed, either temporarily or permanently.

In the example, in which two of the questions of the online survey ask each online survey taker to indicate his or her gender and favorite color, the user has established three quotas. The first quota specifies that the desired number of online survey takers who indicate that their gender is female and that their favorite color is red is four. The second quota specifies that the desired number of online survey takers who indicate that their gender is male and that their favorite color is blue is two. The third quota specifies that the desired number of online survey takers who indicate that their gender is female and that their favorite color is blue is three.

In certain embodiments, the Add Quota interface 400 may additionally provide information pertaining to whether any or all of the specified quotas have been met, e.g., in real-time or at a certain discrete time. In the example, the Add Quota interface 400 indicates that only the second quota has been met so far (i.e., two of the desired two online survey takers to meet the criteria for the second quota have completed the online survey) and further that the first and third quotas will each be met once there is one more online survey taker to match the corresponding criteria (e.g., the first quota will be met once there is a fourth online survey taker who indicates that their gender is female and that their favorite color is red).

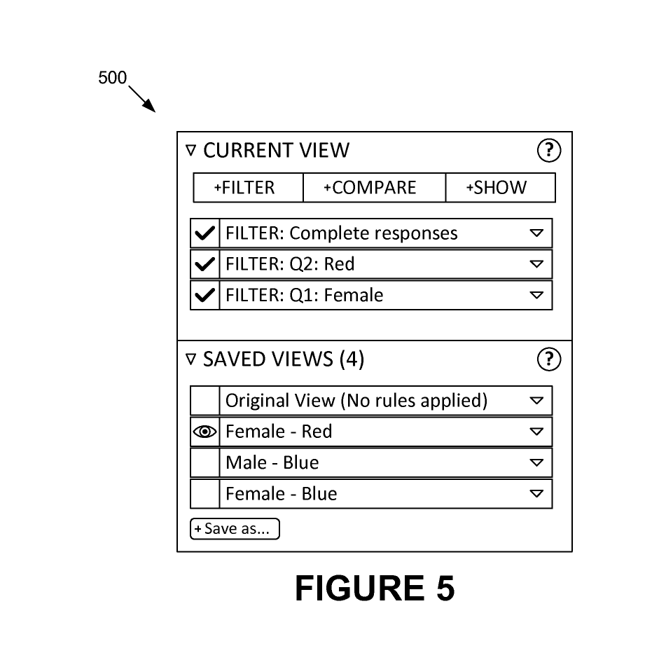

FIG. 5 illustrates an example of an online survey results view interface 500 configured to enable a user to select a certain online survey results view for a particular online survey, e.g., as described at 308 and 310 of the electronic device-controlled method 300 illustrated by FIG. 3, in accordance with certain embodiments of the disclosed technology.

A Current View portion of the online survey results view interface 500 may visually present information pertaining to the filters that have been applied to determine which online survey takers met the specified criteria for the currently selected quota. In the example, three filters have been applied for the quota corresponding to the currently-presented online survey results view: survey takers who have provided answers to the online survey questions, survey takers who answered [in response to Question 2 of the online survey] that their favorite color is red, and survey takers who answered [in response to Question 1 of the online survey] that their gender is female.

A Saved Views portion of the online survey results view interface 500 may visually present an indication of all the online survey results views that are presently available to the user, including those online survey results views that have been automatically generated for the online survey, one for each of the quota equations specified by the survey creator. In the example, the first (e.g., default) view provides the online survey results with no filters applied, the second view provides online survey results for survey takers who indicated that they are females whose favorite color is red, the third view provides online survey results for survey takers who indicated that they are males whose favorite color is blue, and the fourth view provides online survey results for survey takers who indicated that they are females whose favorite color is blue. An icon or other suitable symbol (here, an eye) may be used to indicate within the Saved Views portion of the online survey results view interface 500 which online survey results view is presently selected (here, the second view).

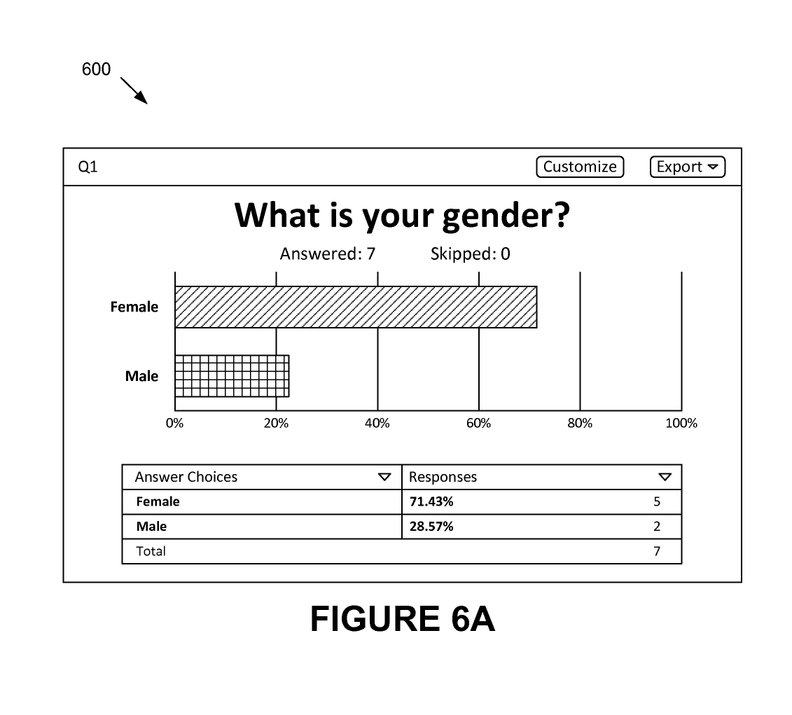

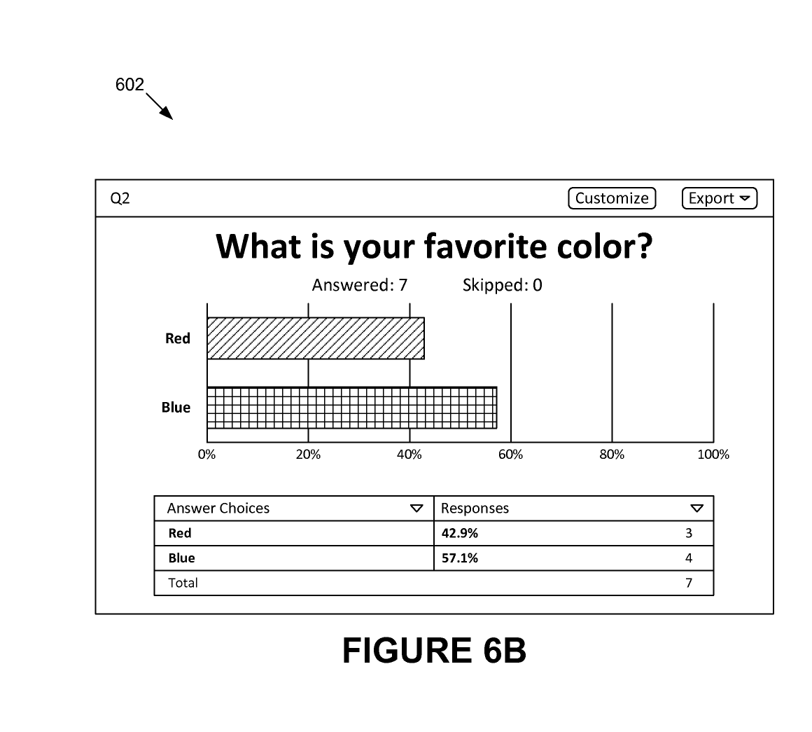

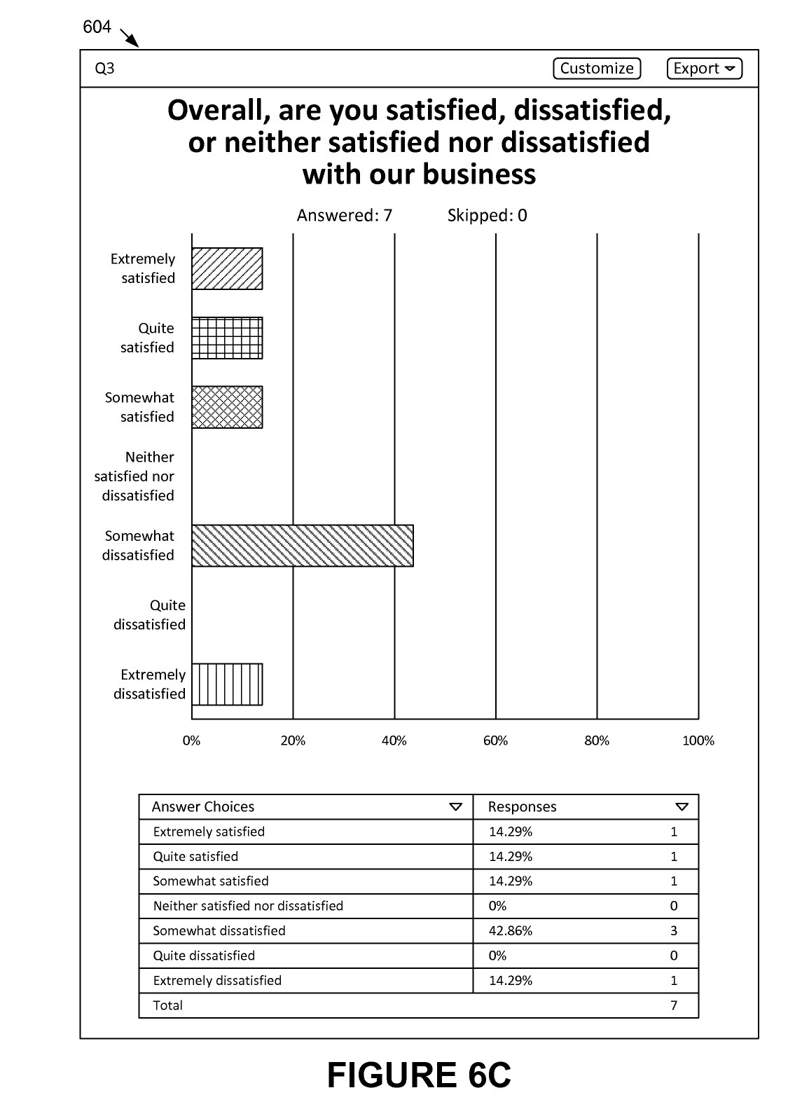

FIG. 6A illustrates a first example of an Answer interface configured to visually provide a user with information pertaining to results for a first question of a particular online survey 600 in accordance with certain embodiments of the disclosed technology. In the example, the first question asks the survey taker to specify his or her gender. The Answer interface 600 indicates that, so far, seven survey takers have answered the question, of which five have answered “female” and two have answered “male.” The Answer interface 600 also provides both visual and numerical representations of the percentage of answers for each answer. The visual representations may include different patterns and/or colors for each answer so as to help a user more readily distinguish each representation.

FIG. 6B illustrates a first example of an Answer interface configured to visually provide a user with information pertaining to results for a second question of the online survey 602 in accordance with certain embodiments of the disclosed technology. In the example, the second question asks the survey taker to specify his or her favorite color. The Answer interface 602 indicates that, so far, seven survey takers have answered the question, of which three have answered “red” and four have answered “blue.” The Answer interface 602 also provides both visual and numerical representations of the percentage of answers for each answer. The visual representations may include different patterns and/or colors for each answer so as to help a user more readily distinguish each representation.

FIG. 6C illustrates a first example of an Answer interface configured to visually provide a user with information pertaining to results for a third question of the online survey 604 in accordance with certain embodiments of the disclosed technology. In the example, the third question asks the survey taker: “Overall, are you satisfied, dissatisfied, or neither satisfied nor dissatisfied with our business?” The Answer interface 604 indicates that, so far, seven survey takers have answered the question, of which three have answered “Somewhat dissatisfied” and one has answered each of “Extremely satisfied,” Quite satisfied,” “Somewhat satisfied,” and “Extremely dissatisfied.” So far, no survey taker has answered “Neither satisfied nor dissatisfied” nor “Quite dissatisfied.” The Answer interface 604 also provides both visual and numerical representations of the percentage of answers for each answer. The visual representations may include different patterns and/or colors for each answer so as to help a user more readily distinguish each representation.

In the example, all of the survey taker responses are presented to the user by the Answer interfaces 600, 602, and 604, indicating that the currently-selected online results view is the default view (e.g., no filters have been applied). However, had the user selected a different view (e.g., the second view in the Saved Views portion of the online survey results view interface 500 of FIG. 5) the information presented to the user would be limited to those responses to the question by survey takers within the corresponding quota (e.g., the interface 604 of FIG. 6C would only present information pertaining to responses to Question 3 of the survey by survey takers who had indicated via Questions 1 and 2 of the survey that they are females and that their favorite color is red).

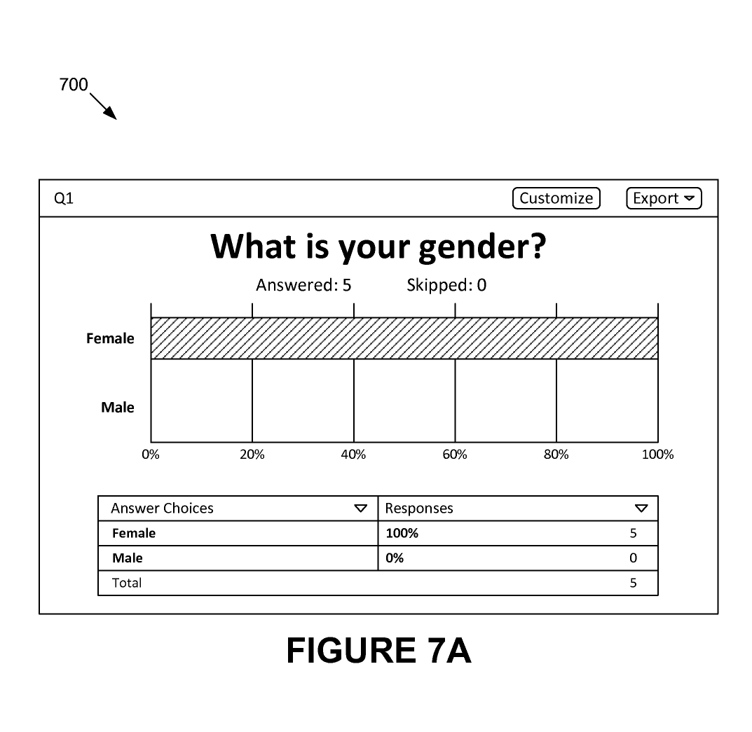

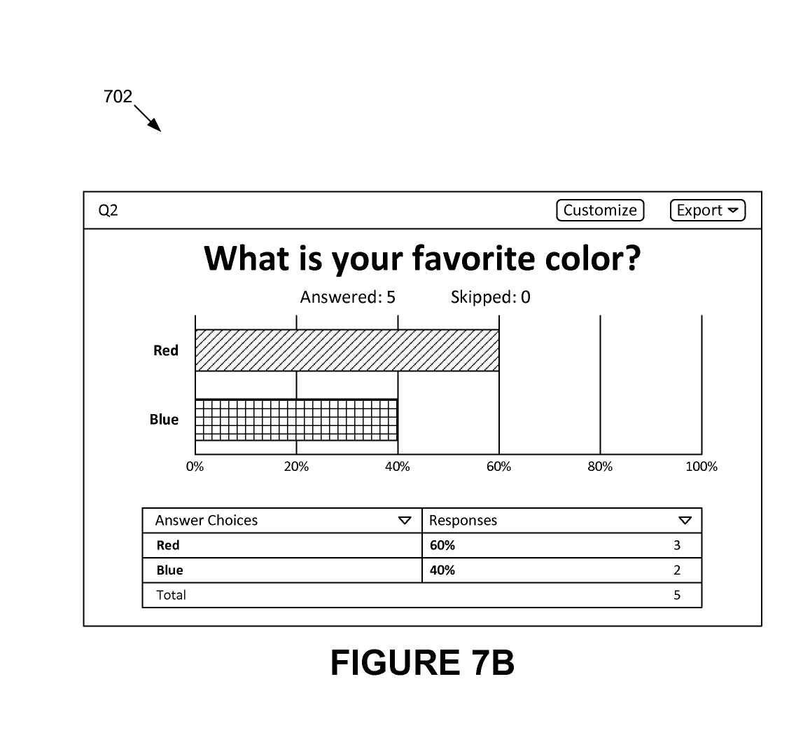

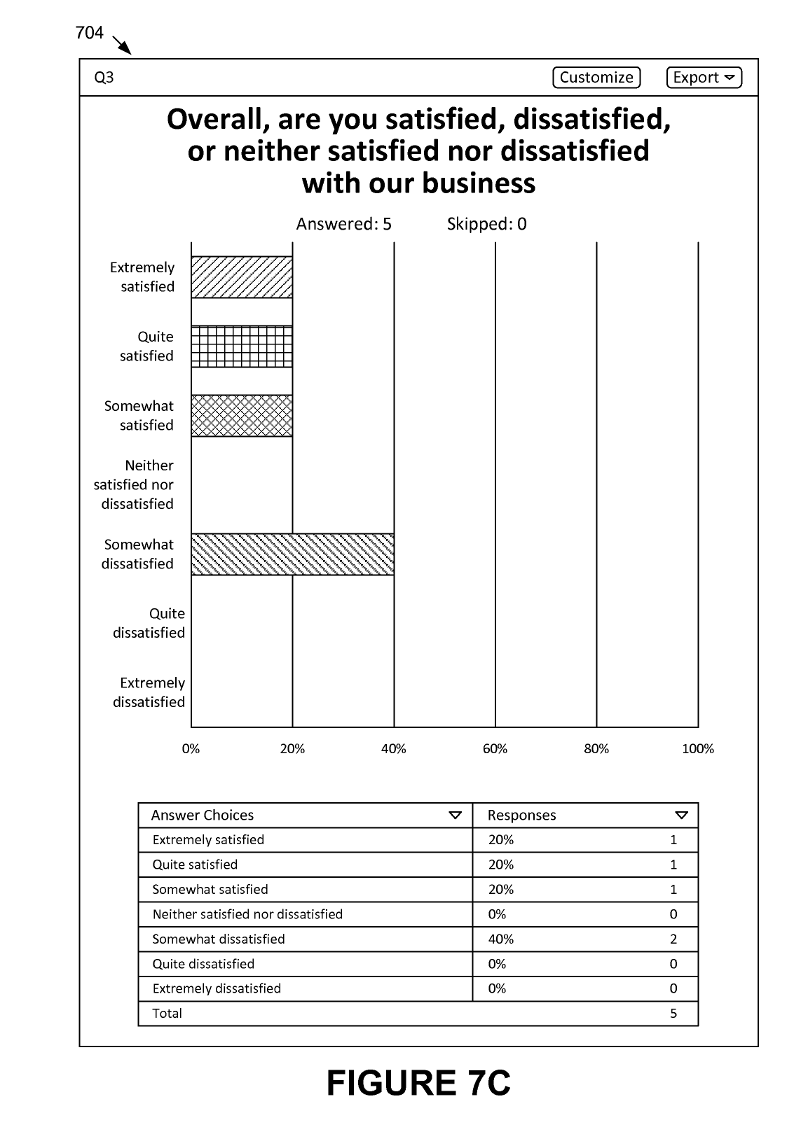

FIG. 7A illustrates a second example of an Answer interface configured to visually provide a user with information pertaining to results for a first question of a particular online survey in accordance with certain embodiments of the disclosed technology. In the example, the first question asks the survey taker to specify his or her gender. The Answer interface 700 indicates that, so far, five survey takers have answered the question, all of whom have answered “female.” The Answer interface 700 also provides both visual and numerical representations of the percentage of answers for each answer. The visual representations may include different patterns and/or colors for each answer so as to help a user more readily distinguish each representation.

FIG. 7B illustrates a second example of an Answer interface configured to visually provide a user with information pertaining to results for a second question of the online survey in accordance with certain embodiments of the disclosed technology. In the example, the second question asks the survey taker to specify his or her favorite color. The Answer interface 702 indicates that, so far, five survey takers have answered the question, of which three have answered “red” and two have answered “blue.” The Answer interface 702 also provides both visual and numerical representations of the percentage of answers for each answer. The visual representations may include different patterns and/or colors for each answer so as to help a user more readily distinguish each representation.

FIG. 7C illustrates a second example of an Answer interface configured to visually provide a user with information pertaining to results for a third question of the online survey in accordance with certain embodiments of the disclosed technology. In the example, the third question asks the survey taker: “Overall, are you satisfied, dissatisfied, or neither satisfied nor dissatisfied with our business?” The Answer interface 704 indicates that, so far, five survey takers have answered the question, of which two have answered “Somewhat dissatisfied” and one has answered each of “Extremely satisfied,” Quite satisfied,” and “Somewhat satisfied.” So far, no survey taker has answered “Neither satisfied nor dissatisfied,” “Quite dissatisfied,” nor “Extremely dissatisfied.” The Answer interface 704 also provides both visual and numerical representations of the percentage of answers for each answer. The visual representations may include different patterns and/or colors for each answer so as to help a user more readily distinguish each representation.

In the example, all of the survey taker responses are presented to the user by the Answer interfaces 700, 702, and 704, indicating that the currently-selected online results view is the default view (e.g., no filters have been applied). However, had the user selected a different view (e.g., the fourth view in the Saved Views portion of the online survey results view interface 500 of FIG. 5) the information presented to the user would be limited to those responses to the question by survey takers within the corresponding quota (e.g., the interface 704 of FIG. 7C would only present information pertaining to responses to Question 3 of the survey by survey takers who had indicated via Questions 1 and 2 of the survey that they are females and that their favorite color is blue).

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. An electronic device-controlled method, comprising:
responsive to instructions from a first user, a first electronic device creating one or more online survey quotas for an online survey, the online survey including a plurality of online survey questions, and each of the one or more online survey quotas having at least one filter associated therewith; and
a second electronic device automatically generating one or more online survey results views for the online survey, each of the one or more online survey results views corresponding to at least one of the one or more online survey quotas.

2. The electronic device-controlled method of claim 1, wherein the first electronic device and the second electronic device are the same device.

3. The electronic device-controlled method of claim 1, wherein at least one of the first and second electronic devices is a mobile electronic device.

4. The electronic device-controlled method of claim 3, wherein the mobile electronic device is a smartphone or a tablet computing device.

5. The electronic device-controlled method of claim 1, further comprising:
a third electronic device visually presenting to a second user an online survey results view interface configured to allow the second user to select a certain one of the one or more online survey results views for the online survey.

6. The electronic device-controlled method of claim 5, wherein at least two of the first, second, and third electronic devices are the same device.

7. The electronic device-controlled method of claim 5, wherein at least one of the first, second, and third electronic devices is a mobile electronic device.

8. The electronic device-controlled method of claim 7, wherein the mobile electronic device is a smartphone or a tablet computing device.

9. The electronic device-controlled method of claim 5, wherein the first and second users are the same user.

10. The electronic device-controlled method of claim 5, further comprising:
the third electronic device receiving a plurality of online survey results including answers to the plurality of questions by a plurality of online survey takers; and
the third electronic device visually presenting to the second user at least a sub-portion of the plurality of online survey results based on the certain one of the one or more online survey results views.

11. The electronic device-controlled method of claim 10, wherein the at least a sub-portion of the plurality of online survey results includes answers to at least one of the plurality of online survey questions by at least one online survey taker within a group defined by one of the one or more online survey quotas.

12. The electronic device-controlled method of claim 11, wherein the group is defined by answers to at least a certain one of the plurality of online survey questions.

13. The electronic device-controlled method of claim 12, wherein the certain one of the plurality of online survey questions asks the survey taker to designate his or her gender.

14. The electronic device-controlled method of claim 11, wherein visually presenting the at least a sub-portion of the plurality of online survey results includes providing a graphical representation, numerical representation, or both graphical and numerical representations of at least some of the answers to at least one of the plurality of online survey questions.

15. An electronic device, comprising:
a memory; and
a processor configured to:
responsive to instructions from a first user, create one or more online survey quotas for the online survey, the online survey including a plurality of online survey questions, and each of the one or more online survey quotas having at least one filter associated therewith; and
automatically generate one or more online survey results views for the online survey, each of the one or more online survey results views corresponding to at least one of the one or more online survey quotas, the memory configured to store the one or more online survey results views.

16. The electronic device of claim 15, further comprising:
a display configured to visually present to a second user an online survey results view interface configured to allow the second user to select a certain one of the one or more online survey results views for the online survey.

17. The electronic device of claim 15, wherein the display is further configured to visually present to the second user at least a sub-portion of a plurality of online survey results based on the certain one of the one or more online survey results views, the plurality of online survey results including answers to the plurality of questions by a plurality of online survey takers.

18. The electronic device of claim 17, wherein the at least a sub-portion of the plurality of online survey results includes answers to at least one of the plurality of online survey questions by at least one online survey taker within a group defined by one of the one or more online survey quotas.

19. The electronic device of claim 18, wherein the group is defined by answers to at least a certain one of the plurality of online survey questions.

20. The electronic device of claim 17, wherein the display is configured to visually present the at least a sub-portion of the plurality of online survey results by providing a graphical representation, numerical representation, or both graphical and numerical representations of at least some of the answers to at least one of the plurality of online survey questions.
